(19) United States
(12) Patent Application Publication
(10) Pub. No.: US 2026/0232506 A1
(43) Pub. Date: Aug. 13, 2026

(54) MOBILITY ASSISTIVE SYSTEMS, DEVICES, AND RELATED METHODS

(71) Applicant: REVIMO INCORPORATED, Newton, MA (US)

(72) Inventor: Aleksandr Malashchenko, Newton, MA (US)

(21) Appl. No.: 19/468,561

(22) Filed: Feb. 3, 2026

Related U.S. Application Data
(63) Continuation of application No. PCT/US2024/040928, filed on Aug. 5, 2024.
(60) Provisional application No. 63/530,648, filed on Aug. 3, 2023.
(60) Provisional application No. 63/632,708, filed on Apr. 11, 2024.

(51) Int. Cl. A61G 5/14; A61G 7/10

(52) U.S. Cl. CPC A61G 5/14; A61G 7/1019; A61G 7/1036; A61G 7/1048; A61G 7/1059; A61G 7/1092

(57) ABSTRACT

A mobility assistive device for a user is disclosed. The disclosed mobility device can include a main frame, an arm rest coupled to the main frame, a back rest coupled to the arm rest, a movable seat coupled to the main frame, a seat lifting mechanism coupled to the seat and the main frame, and an arm rest lifting mechanism coupled to the arm rest and the main frame.

### CROSS-REFERENCE TO RELATED APPLICATIONS

This application is a continuation of International Patent Application No. PCT US2024/040928 filed Aug. 5, 2024, which claims priority to and the benefit of U.S. Provisional Patent Application No. 63/530,648, entitled “MOBILITY DEVICE AND METHODS FOR SAME” filed on Aug. 3, 2023 and U.S. Provisional Patent Application No. 63/632,708, entitled “MOBILITY ASSISTIVE DEVICE” filed on Apr. 11, 2024, the entire teachings of which are incorporated herein by reference.

### FIELD

The present disclosure generally relates to the field of mobility assistive devices, and more particularly to assistive systems, methods, and devices for assisting individuals to come to a seated or standing position and to transfer to a destination.

### BACKGROUND

Conventional mobility assistive devices that assist individuals with mobility issues, such as the elderly or those who have been injured have been known in the art. For example, conventional mobility assistive devices, such as crutches and walkers, are often used for walking or moving around a space. However, such assistive devices typically require an individual to support their body weight by alternating (or distributing) the weight from their legs to arms and shoulders. This transitioning of the weight from the legs to the arms and shoulders can place stress on other parts of the body, such as the person's ankle, knee, hip, wrist, elbow and shoulder joints. Further, for individuals, such as the elderly or those who are healing from an injury, standing to use these conventional mobility assistive devices can be difficult or impossible and often times limit the individuals' ability to use these devices without significant pain or discomfort. Furthermore, because these devices require the individual to use their arms to move about, the individual's arms are not free to use for other purposes (e.g., carrying things).

Alternatively, many of these individuals may be forced to use a wheelchair to address their mobility issues. Though using a wheelchair liberates the individual to be in a standing position, the wheelchair can still require the individual to use their arms to move about, preventing the arms from being used for other purposes. However, transfer from a bed to a wheelchair requires high physical effort or assistance from one or several caregivers, which restricts the ability of these individuals to move around and perform self-care tasks independently and causes mental problems and accompanying diseases.

### SUMMARY

The present disclosure relates to systems, devices, and methods for providing mobility assistance to user via a mobility assistive device. In one aspect, the present disclosure relates to mobility assistive systems, devices, and corresponding methods that assist individuals in moving directly from a seated position, while unaided and without significant pain or discomfort. In other aspects, mobility assistive systems, devices, and methods are disclosed that allows individuals to move around while not requiring constant use of the individual's arms.

According to one aspect of the present disclosure, there is provided a mobility assistive device comprising a main frame, an arm rest coupled to the main frame, a handlebar movably coupled to the main frame, a back rest coupled to the arm rest, a seat movably coupled to the main frame, a seat lifting mechanism coupled to the seat and the main frame, a handlebar lifting mechanism coupled to the handlebar and the main frame, and an arm rest lifting mechanism coupled to the arm rest and the main frame. The arm rest is configured to move along a horizontal plane of the main frame and along a vertical axis of the main frame. The handlebar is configured to move along the vertical axis of the main frame and assist the user to lift the body of the user from the seated position. The back rest is configured to support a portion of the user's body. The seat is configured to move about the main frame in a scooping motion. The seat lifting mechanism is configured to move the seat along the vertical axis of the main frame. The arm lifting mechanism is configured to move the arm rest along the vertical axis of the main frame. The handlebar lifting mechanism is configured to move the handlebar along the vertical axis of the main frame.

In other examples, the aspects above, or any system, method, apparatus described herein can include one or more of the following features.

The arm rest of the mobility assistive device can comprise a left arm rest section, a right arm rest section, a left connection segment, where a distal end of the left connection segment is movably connected to the left arm rest section, a right connection segment, where a distal end of the right connection segment is movably connected to the right arm rest section, and a rotating block disposed on the main frame and configured to rotate about the vertical axis of the main frame and connect to a proximal end of the left connection segment and a proximal end of the right connection segment.

The left arm rest section and the right arm rest section of the mobility assistive device can be configured to move along the horizontal plane of the main frame by actuation of the rotating block, the left arm connection segment, and the right arm connection segment.

The actuation of the rotating block, the left arm connection segment, and the right arm connection segment can be an actuation via at least one actuator disposed on the rotating block.

The back rest of the mobility assistive device can comprise a left section and a right section, where the left section of the backrest is coupled to the left arm rest section and the right section of the backrest is coupled to the right arm rest section.

The mobility assistive device can further comprise at least one actuator configured to move the left arm rest section and the right arm rest section about the vertical axis of the main frame.

The seat of the mobility assistive device can comprise a left seat section, a right seat section, and a seat movement mechanism configured to move the left seat section and the right seat section along the vertical axis of the main frame and simultaneously rotate the left seat section and the right seat section about a horizontal axis of the main frame to close in the scooping motion to form the seat, where the seat movement mechanism further includes at least one actuator configured to move the left seat section and the right seat section simultaneously along the vertical axis of the main frame and rotate the left seat section and the right seat section about the horizontal axis of the main frame.

The seat lifting mechanism of the mobility assistive device can comprise a carriage in contact with each of the left seat section and the right seat section, the carriage configured to contain the at least one actuator and the seat movement mechanism, an eccentric block contained within the carriage, and in contact with each of the left seat section and right seat section, the eccentric block configured to rotate each of the left seat section and the right seat section when contacted by the seat movement mechanism contained within the carriage, and a slot plate configured to allow the carriage, the eccentric block, the left seat section, and the right seat section to move along the vertical axis of the main frame and simultaneously rotate about a horizontal axis of the main frame via the at least one actuator contained within the carriage.

The seat movement mechanism of the seat can include a gear disposed on a seat shaft of each of the left seat section and the right seat section and a gear track configured to receive the gear, where the gear is configured to rotationally move about along the gear track to rotate each of the left seat section and the right seat section and move the left seat section and the right seat section simultaneously along the vertical axis of the main frame.

The seat movement mechanism can further include a carriage in contact with each of the left seat section and the right seat section, the carriage configured to contain a bearing, a linear actuator configured to be functionally coupled to the carriage in each of the left seat section and the right seat section and configured for movement of the each of the left seat section and the right seat section along the vertical axis of the main frame, and a rotary actuator configured to be functionally coupled to the carriage in each of the left seat section and the right seat section, the rotary actuator configured for movement of the each of the left seat section and the right seat section in a scooping motion.

The seat movement mechanism can further include a seat shaft movably coupled with the seat via at least one seat arm, a seat supporting shaft movably coupled to the seat and contained with the arm rest, and a seat actuator disposed on a seat shaft and configured to connect the back rest with each of the left seat section and the right seat section and configured to move the seat shaft, the at least one seat arm, the left seat section, and the right seat section in a scooping motion when actuated and move the back rest simultaneously with moving the left seat section and the right seat section

The mobility assistive device can further include at least one support leg attached to the main frame and at least one selectively rolling wheel disposed on the at least one support leg and configured to allow the user to move the mobility assistive device.

The at least one selectively rolling wheel can include six selectively rolling wheels.

Alternatively or additionally, the at least one selectively rolling wheel can include four selectively rolling wheels.

The mobility assistive device can further include an electric control module disposed on the arm rest, and the handlebar or main frame, where the electric control module configured to allow the user to control movement of the at least one selectively rolling wheel.

The electric control module can be further configured to allow the user to control movement of the handlebar, the arm rest, the support legs and the seat.

The electric control module can be further configured to be controlled by voice control.

The electrical control module can include programmable routes for the autonomous movement of the mobility assistive device without direct control by a user.

The movement of the mobility assistive device can be controlled via the programmable routes and movements activated by the voice control.

The electric control module can further include at least one tactile feature configured to be operable by the user to allow the user to control the mobility assistive device.

The main frame of the mobility assistive device can further include at least one sensor configured to prevent the mobility assistive device from colliding with other objects during movement and also to position the mobility assistive device alongside the body of the user. The at least one sensor can be an image capture sensor (i.e., a video camera) which is configured to prevent the mobility assistive device from colliding with other objects during movement and also to position the mobility assistive device alongside the body of the user.

The backrest of the mobility assistive device can be configured to support a lower back region of the user's body. The backrest of the mobility assistive device can further be configured to support a region of the user's body directly under the user's arms.

The at least one actuator of the mobility assistive device can further include a first actuator disposed on the left arm rest section and configured to move the left arm rest section about the vertical axis of the main frame and a second actuator disposed on the right arm rest section and configured to move the right arm rest section about the vertical axis of the main frame. The left arm rest section and the right arm rest section can be configured to move simultaneously. Alternatively, the left arm rest section and the right arm rest section can move independently of each other.

The mobility assistive device can be configured to be used for rehabilitation training. Alternatively or additionally, the mobility assistive device can be configured to be used for gait training.

Other aspects and advantages of the invention can become apparent from the following drawings and description, all of which illustrate the various aspects of the invention, by way of example only.

### BRIEF DESCRIPTION OF THE DRAWINGS

FIG. 1A is a schematic illustration of a mobility assistive device according to some aspects disclosed herein.

FIG. 1B is another schematic illustration of the mobility assistive device.

FIG. 1C is yet another illustration of the mobility assistive device.

FIG. 2A is an illustration of system with an arm rest according to some aspects disclosed herein.

FIG. 2B is an illustration of a system having a rotational mechanism controlling the arm according to some aspects disclosed herein.

FIG. 3A illustrates perspective views of an aspect of the mobility assistive device.

FIG. 3B-3E illustrate a seat lifting mechanism according to aspects of the mobility assistive device disclosed herein.

FIG. 4 illustrate an aspect of the mobility assistive device disclosed herein.

FIG. 5A shows a schematic of a use of the arm rest and seat of the mobility assistive device according to some aspects disclosed herein.

FIG. 5B shows a schematic of a use of the arm rest and seat of the mobility assistive device.

FIG. 5C shows a schematic of a use of the handlebar, the arm rest and the seat of the mobility assistive device.

FIG. 6 illustrate perspective views of the support legs of the mobility assistive device.

FIG. 7 shows an example use of the mobility assistive device to be used in rehabilitation training to assist the user to stand-up.

FIG. 8 shows an example use of the mobility assistive device to be used in gait training to assist the user to walk while assisted.

### DESCRIPTION

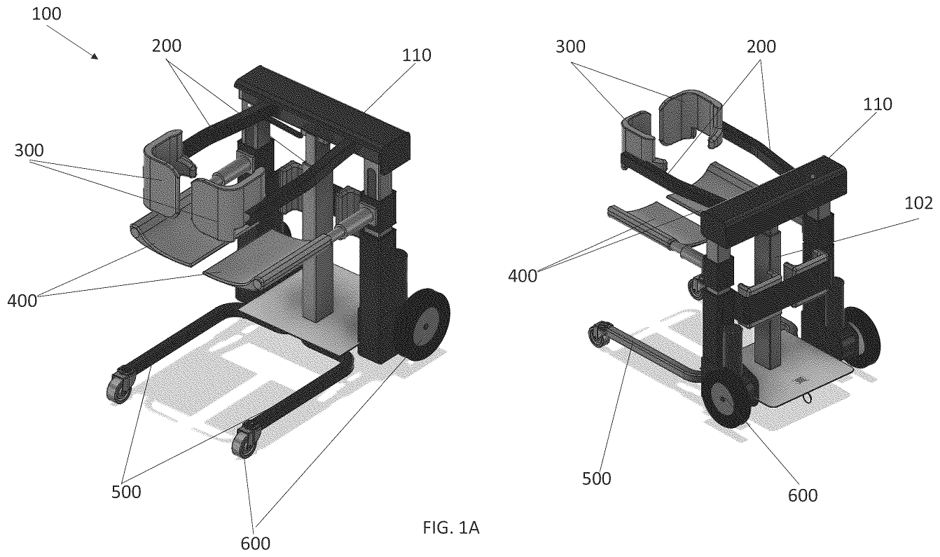

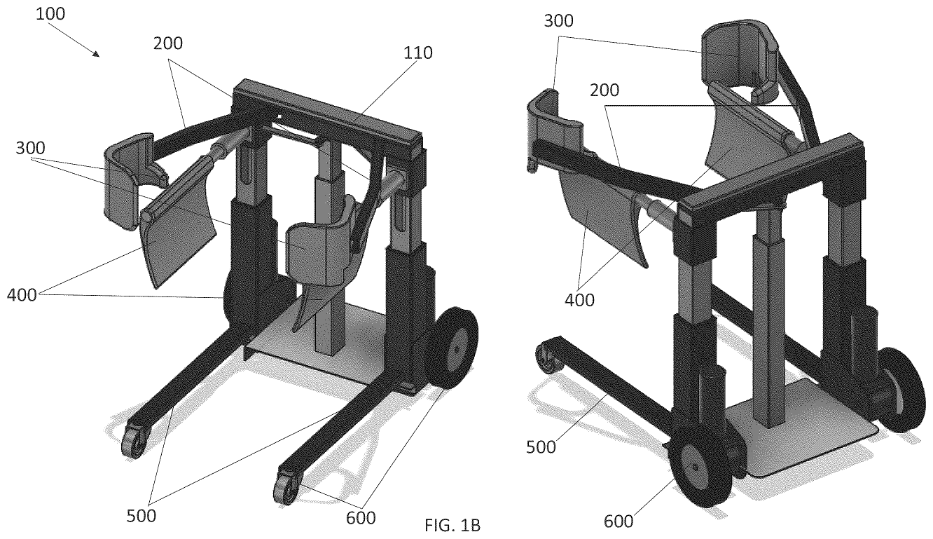

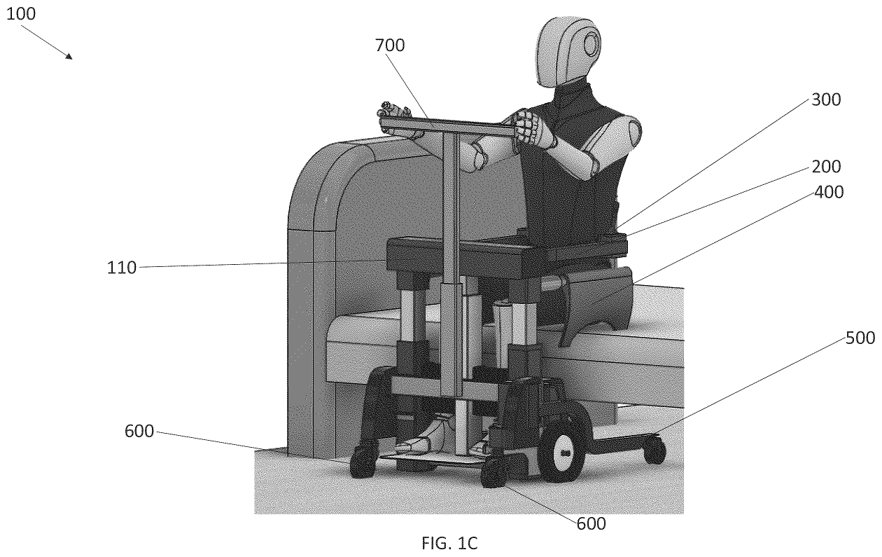

Referring to the drawings, an illustrative aspect of a mobility assistive device 100 is presented. FIGS. 1A-1C show examples of perspective views of an embodiment of the mobility assistive device 100 in engaged and disengaged positions. FIGS. 1A-1C also present the primary structural components of the mobility assistive device 100. These include a main frame 110, an arm rest 200 coupled to the main frame 110, a back rest 300 disposed on the arm rest 200, a seat 400 coupled to the main frame 110, support legs 500 and rolling wheels 600.

The arm rest 200 includes a left arm rest section 200a and a right arm rest section 200b. The back rest 300 includes a left section 300a and right section 300b, where the left section 300a of the back rest 300 is disposed on the left arm rest section 200a and the right section 300b of the back rest 300 is disposed on the right arm rest section 200b. In FIGS. 1A-1C, the left arm rest section 200a and the right arm rest section 200b are movable relative to a horizontal plane of the main frame 110. In an engaged position as shown in FIG. 1A, the left arm rest section 200a and right arm rest section 200b can be moved closer together, relative to each other, in the horizontal plane of the main frame 110 such as both arm rest sections may be closer to the body of the user and the left section 300a and right section 300b of the back rest 300 support a portion of the user's body. In a disengaged position as shown in FIG. 1B, the left arm rest section 200a and right arm rest section 200b can be moved further apart, relative to each other, in the horizontal plane of the main frame 110 such as both arm rest 200 sections may be positioned further away from the body of the user and the left section 300a and right section 300b of the back rest 300 are not supporting the portion of the user's body.

The seat 400 includes a left seat section and a right seat section. In FIGS. 1A-1C, the left seat section and the right seat section are movable about a horizontal axis and a vertical axis of the main frame 110 via a seat movement mechanism. In the engaged position as shown in the FIG. 1A, the left seat section and right seat section can be rotated to form the seat 400 to be able to support the user's body in a seated position. In a disengaged position as shown in FIGS. 1B and 1C, the left seat section and the right seat section can be rotated away such that there is no seat 400 formed and the user can disengage from the mobility assistive device 100.

The device 100 further includes a lifting mechanism 102 disposed on the main frame 110, where the lifting mechanism 102 allows for the left arm rest section 200a and right arm rest section 200b to move along the vertical axis of the main frame 110. The lifting mechanism 102 further includes an actuator (not shown in the figure) for the movement of the left arm rest section 200a and the right arm rest section 200b to move along the vertical axis of the main frame 110.

The lifting mechanism 102 can also be configured to allow the left seat section 400a and right seat section 400b to move along the vertical axis of the main frame 110. Alternatively, the arm rest 200 and the seat 400 can have separate lifting mechanisms.

Referring to FIG. 1C, the mobility assistive device 100 further includes a handlebar 700 configured for a user to hold to provide support when lifting their body from a seated position. In FIG. 1C, the handlebar 700 is disposed on the main frame 110 and is configured to move along the vertical axis of the main frame 110 via the lifting mechanism 102 disposed on the main frame 110. Further, the handlebar 700 can further include friction grips (not shown in the figure) disposed on distal ends of the handlebar 700 to allow the user to grip the handlebar 700 without slipping. Alternatively, the handlebar 700 can also be configured to move along the vertical axis of the main frame 110 via a handlebar lifting mechanism (not shown in the figure) disposed on the main frame 100 and separate from the lifting mechanism 102.

The main frame 110 of the mobility assistive device 100 can include at least one sensor (not shown in figures) to prevent the mobility assistive device 100 from colliding with other objects during movement and also to position the mobility assistive device 100 alongside the body of the user. Alternatively, the main frame 110 of the mobility assistive device 100 can include at least one video camera (not shown in figures) to prevent the mobility assistive device 100 from colliding with other objects during movement and also to position the mobility assistive device 100 alongside the body of the user.

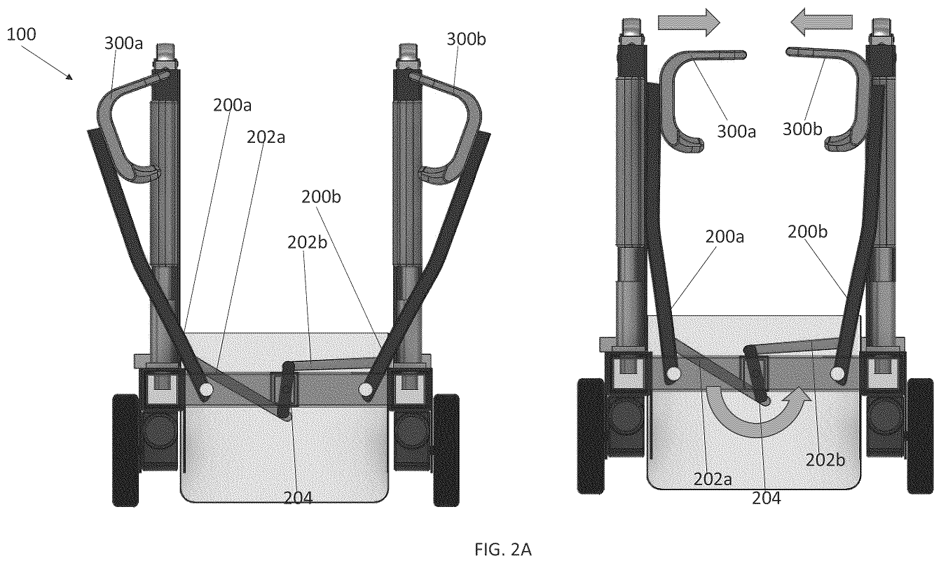

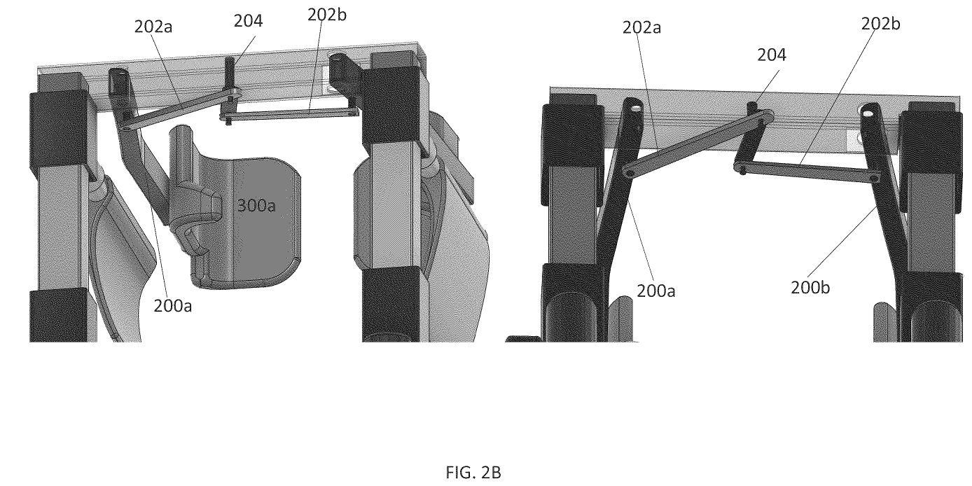

FIG. 2A shows examples of top views of the arm rest 200 in engaged (left) and disengaged (right) positions without a user present. FIG. 2B shows examples of perspective views of a rotational mechanism controlling the arm rest 200 in engaged (left) and disengaged (right) positions without a user present in the mobility assistive device 100. FIG. 2A also presents the primary structural components of the arm. These include the left arm rest section 200a, the right arm rest section 200b, a left connection segment 202a, a right connection segment 202b and a rotating block 204.

As shown in in FIGS. 2A and 2B, a distal end of the left connection segment 202a is connected to the left arm rest section 200a and a distant end of the right connection segment 202b is connected to the right arm rest section 200b. The proximal ends of both the left connection segment 202a and the right connection segment 202b are connected to a rotating block disposed on the main frame 110 of the mobility assistive device 100. In FIG. 2A, when the mobility assistive device 100 is in the disengaged position, the left arm rest section 200a and the right arm rest section 200b can be positioned further apart, relative to each other, from the user's body. When the mobility assistive device 100 is in the engaged position, the rotating block may be actuated such that rotation of the rotating block pulls the left arm rest section 200a and right arm rest section 200b closer together, relative to each other, via the left connection segment 202a and the right connection segment 202b, such that the left arm rest section 200a and the right arm rest section 200b can be closer to the user's body.

In FIG. 2B, the actuation of the rotating block disposed on the main frame 110 can also cause movement of the left arm rest section 200a and right arm rest section 200b along a horizontal plane of the main axis via the left connection segment 202a and the right connection segment. In the engaged position of the mobility assistive device 100 as shown in FIG. 1A, actuation of the rotating block as shown in FIG. 2B (left), can move the left arm rest section 200a and right arm rest section 200b closer together towards each other. In the disengaged position of the mobility assistive device 100 as shown in FIGS. 1B and 1C, actuation of the rotating block as shown in FIG. 2B (right), can move the left arm rest section 200a and right arm rest section 200b further away from each other.

The actuation of the rotation block 204 can be done manually via a hydraulic actuator controlled by the user. Alternatively, the actuation of the rotation block 204 can be done electronically via an electric actuator controlled by the user.

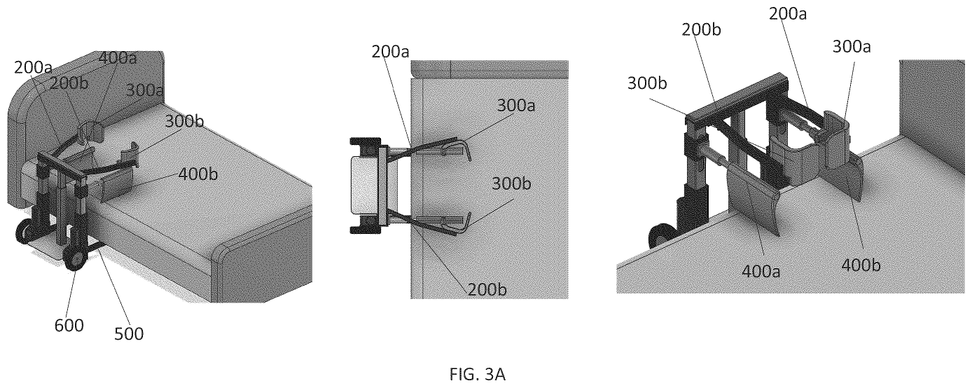

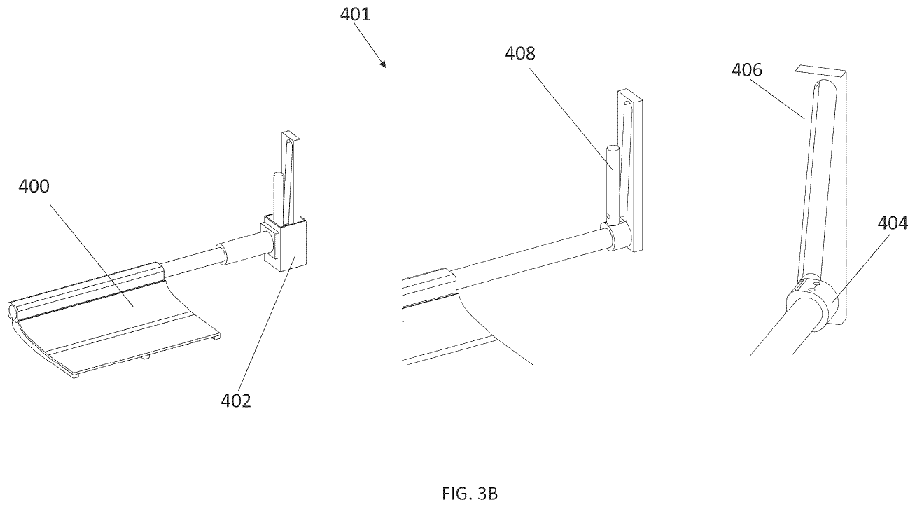

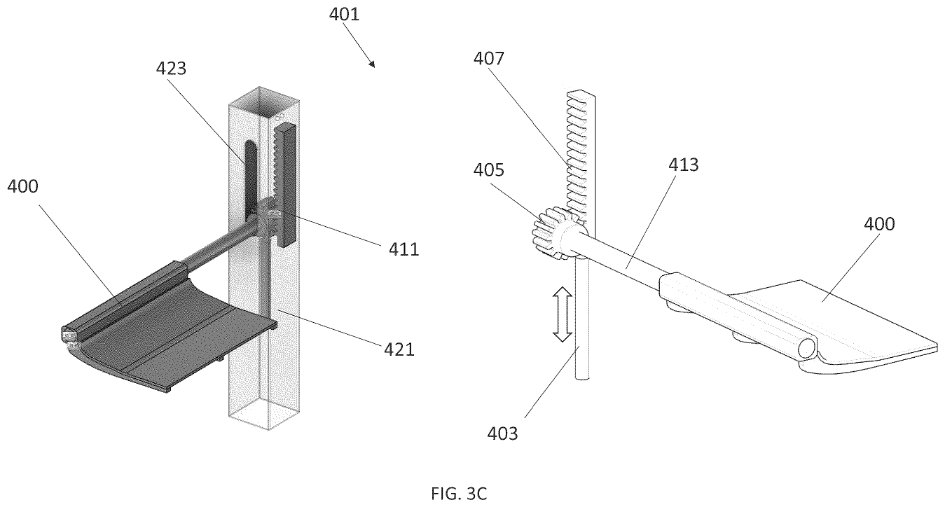

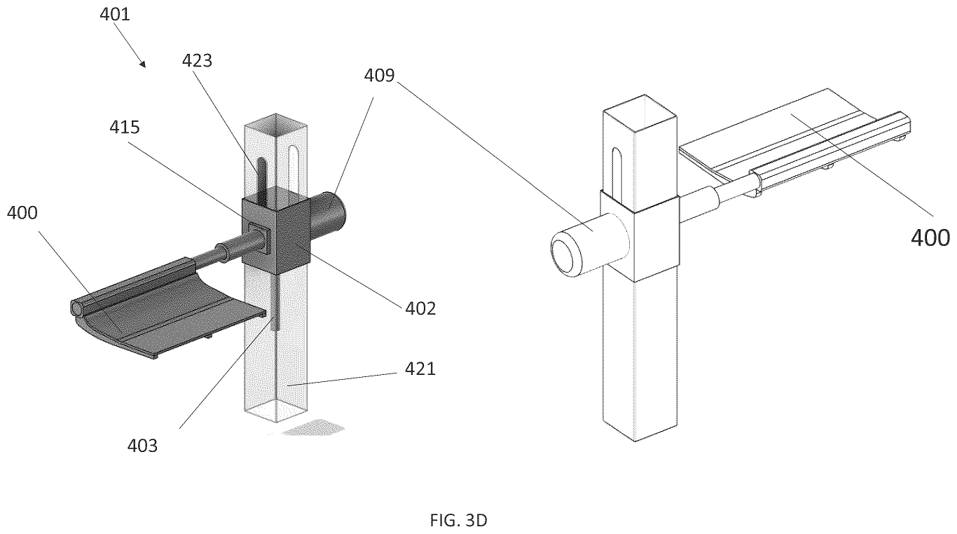

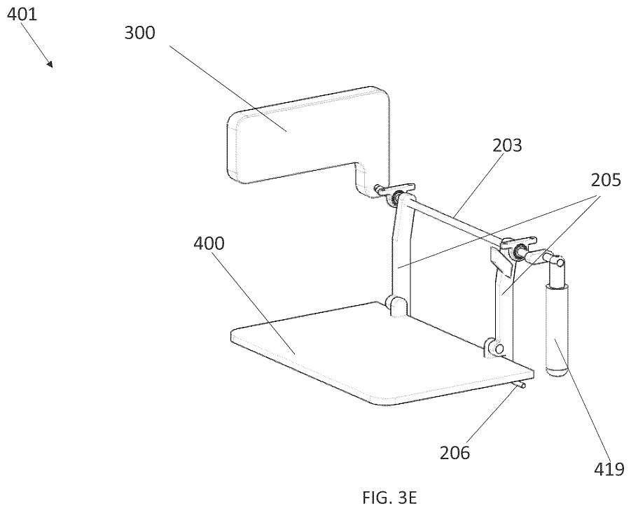

FIG. 3A shows examples of perspective views of the mobility assistive device 100 in a disengaged position at bedside without a user present. In FIG. 3A, the mobility assistive device 100 can be positioned at the bedside of a user via support legs 500 configured to move under the bed when the mobility assistive device 100 is in a disengaged position as shown in FIGS. 1B and 1C. This can necessitate minimal effort for the user to engage with the mobility assistive device 100. In FIG. 3A, once the mobility assistive device 100 is positioned at the bed side of the user, the user can control the movement of the arm rest 200 via arm rest lifting mechanism and the user can control the movement of the seat 400 via the seat lifting mechanism.

FIG. 3B shows examples of perspective views of the seat movement mechanism 401 controlling a seat 400 of the mobility assistive device 100. The seat movement mechanism 401 includes a carriage 402, an eccentric block 404, and a slot plate 406 for each of the left seat section 400a and the right seat 400b section. The carriage 402 includes an actuator 408 configured for vertical movement of each of the seat sections. The eccentric block 404 is contained within the carriage 402 and is in contact with the each of the seat 400 sections. The eccentric block 404 can be configured to move each of the seat 400 sections in a scooping motion via contacting the slot plate 406. The carriage 402 and the eccentric block 404 (in contact with each of the sections of the seat 400) can be configured to move along the vertical axis of the main frame 110 in a vertical column 421 (not shown in FIG. 3B) In FIG. 3B, the carriage 402 further includes an actuator 408 for the movement of the carriage 402 and eccentric block 404 along the vertical axis of the main frame 110.

FIG. 3C shows examples of perspective views of the seat movement mechanism 401 controlling a seat of the mobility assistive device 100. The seat movement mechanism 401 includes a carriage (not shown in the figure), a linear actuator 403, and a rotation mechanism 411, and the vertical column 421 for each of the left seat section 400a and the right seat section 400b. In the embodiment presented in FIG. 3C, the rotation mechanism 411 includes a gear 405 disposed on a seat shaft 413 of each section of the seat 400 and a gear rack 407 that is configured to receive the gear 405. The gear 405, disposed in the seat shaft 413 of each section of the seat 400, can be configured to travel along the gear rack 407 and move each section of the seat 400 in a scooping motion about the horizontal axis of the main frame 110. In FIG. 3C, the linear actuator 403 can be configured for the movement of each section of the seat 400 along the vertical axis of the main frame 110. Additionally, the vertical movement of each of the seat 400 sections can be limited by the length of the slot 423 disposed on the vertical column 421.

FIG. 3D shows examples of perspective views of the seat movement mechanism 401 controlling a seat 400 of the mobility assistive device 100. The seat lifting mechanism 401 includes a carriage 402 with a bearing 415, a linear actuator 403, and a rotary actuator 409 for each of the left seat section 400a and the right seat section 400b. In FIG. 3D, the rotary actuator 409 can be configured to move each of the seat 400 sections in a scooping motion. Additionally, in FIG. 3D, the linear actuator 403 can also be configured for the movement of the each of the seat 400 sections along the vertical axis of the main frame 110. Additionally, the vertical movement of each of the seat 400 sections can be limited by the length of the slot 423 disposed on the vertical column 421.

FIG. 3E shows examples of perspective views of the seat movement mechanism 401 controlling a seat 400 of the mobility assistive device 100. In FIG. 3E, the seat lifting mechanism 401 includes a seat actuator 419 disposed on a seat shaft contained within the arm rest 200 and connecting the back rest 300 with each of the left seat section 400a and the right seat section 400b. The seat shaft 203 is disposed on the armrest 200 and is movably coupled with the seat 400 via at least one seat arm 205. The seat 400 is in contact with a seat supporting shaft 206 contained with the arm rest 200. The seat actuator 419 of FIG. 3E can be configured to move each of the seat shafts 206, the seat arms 206 and seat 400 sections in a scooping motion when actuated. Additionally, the actuation of the seat actuator 419 can also cause the rotation of the back rest 300.

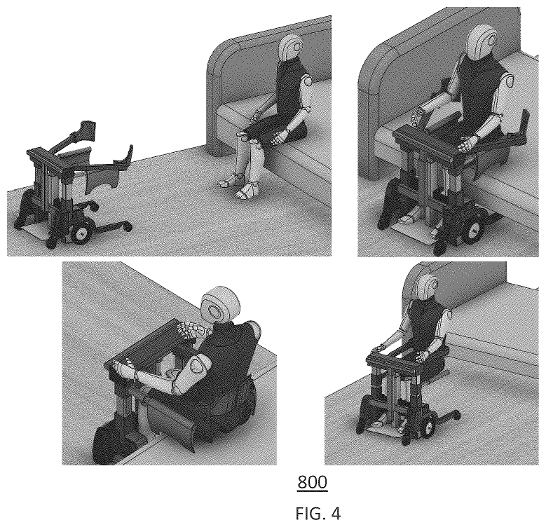

FIG. 4 shows an example use 800 of the mobility assistive device 100 with a user present. The device 100 comprises an electrical control module, present on the main frame 110, the handlebar 700 or the arm rest 200, configured to allow the user to control the movement of the handlebar 700, the arm rest 200, the seat 400, and the rolling wheels 600. The electrical control module can further include a tactile feature (i.e., joystick, button, etc.) for the user to interact with the control the mobility assistive device 100. Furthermore, the device 100 can comprise a wireless remote control configured for the user to interact with the electrical control module remotely to control the movement of the mobility assistive device 100. The electrical control module can be configured to allow the user to control the mobility assistive device 100 via voice control. The electrical control module can further include programmable routes for the movement of the mobility assistive device 100. The programmable routes can be activated when the mobility assistive device 100 is in an engaged position with the user present. Alternatively, the mobility assistive device 100 can be configured follow the programmable routes when activated in a disengaged position without the user present. The mobility assistive device 100 can be activated to follow the programmable routes via the voice control.

Referring to FIG. 4, the mobility assistive device 100 can be positioned at the bedside of the user in a disengaged position (FIGS. 1B and 1C) by the user, by a helper, or via the wireless remote control. The user can control the electrical control module to control the movement of the arm rest 200 such that the left arm rest section 200a and right arm rest section 200b can be closer to the user's body and the left section 300a, and the right section 300b of the back rest 300 are supporting a portion of the user's body. The left section 300a and the right section 300b of the back rest 300 can be configured to support a lower back region of the user's body. The left section 300a and the right section 300b of the back rest 300 can be configured to support a region of the user's body directly under the user's arms. The user can control the electronic control module to control the left seat section and the right seat section to form the seat 400 to support a lower portion of the user's body. The user then can actuate the electronic control module to control movement of the mobility assistive device 100 via the rolling wheels 600.

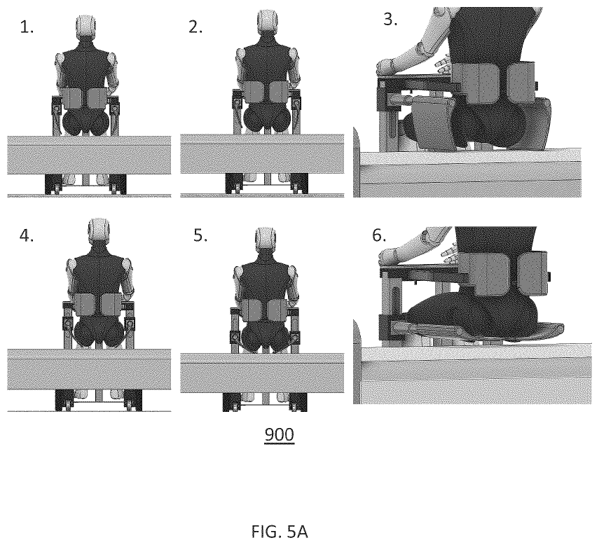

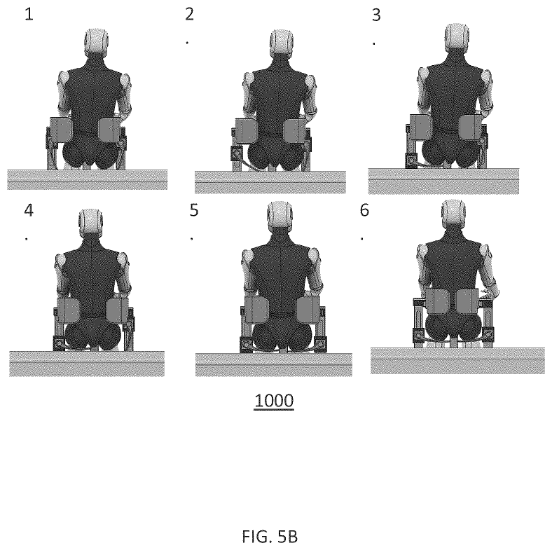

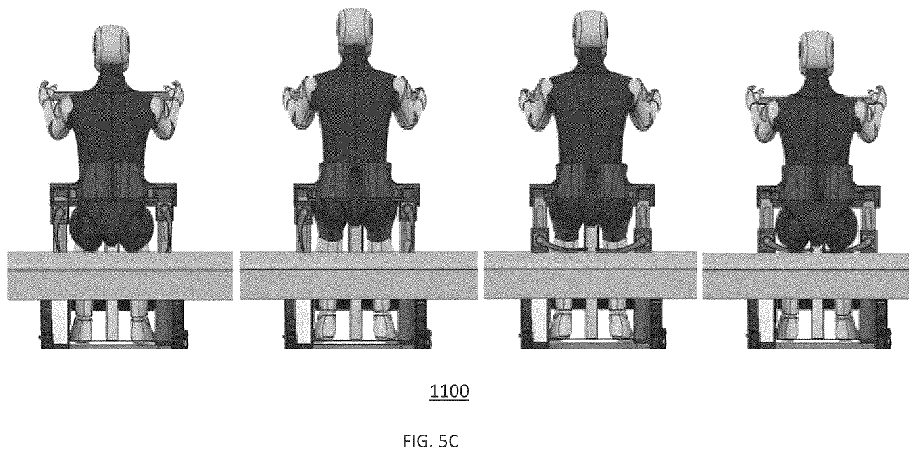

FIG. 5A shows an example use 900 of the arm rest 200 and seat 400 when mobility assistive device 100 is in an engaged portion. The user can actuate the electronic control module (not shown in figures) to control the movement of the left arm rest section 200a and right arm rest section 200b to move along the horizontal plane of the main frame 110 such that both the arm rest 200 sections can be positioned closer to the user's body and where the left section 300a and the right section 300b of the back rest 300 are supporting the portion of the user's body. The user can then actuate the electronic control module to move the arm rest in vertical axis of the main frame 110 to lift the bottom portion of the user's body from the seated position. The user can further actuate the electronic control module to move the left seat section the right seat section in a scooping motion to form the seat 400 under the bottom portion of the user's body for the user to sit on. The user can then actuate the electronic control module to control movement of the mobility assistive device 100.

FIG. 5B shows an example use 1000 of the arm rest 200 and seat 400 when mobility assistive device 100 is in an engaged portion. The user can actuate the electronic control module to control the movement of the left arm rest section 200a and right arm rest section 200b to move along the horizontal plane of the main frame 110 such that both the arm rest 200 sections can be positioned closer to the user's body and where the left section 300a and the right section 300b of the back rest 300 are supporting the portion of the user's body. The user can then lean on the right arm rest section 200b for support by shifting their body weight to the right. The user can then actuate the electronic control module to move the left seat section in a scooping motion to support a left portion of the bottom portion of the user's body. The user can then lean on the left arm rest section 200a for support by shifting their body weight to the left. The user can then activate the electronic control module to move the right seat section in a scooping motion to support a right portion of the bottom portion of the user's body. This forms the seat 400 under the bottom portion of the user's body for the user to sit on. The user can then actuate the electronic control module to control movement of the mobility assistive device 100.

FIG. 5C shows an example use 1100 of the handlebar(s) 700, the arm rest 200 and the seat 400 when mobility assistive device 100 is in an engaged portion. The user can also actuate the electronic control module to control the movement of the left arm rest section 200a and right arm rest section 200b to move along the horizontal plane of the main frame 110 such that both the arm rest sections can be positioned closer to the user's body and where the left section 300a and the right section 300b of the back rest 300 are supporting the portion of the user's body. The user can also actuate the electronic control module to control the movement of the handlebar 700 along the vertical axis of the main frame 110. The user can then grip on the handlebar 700 to lift their body from a seated position and control the electronic control module to move the left seat section and the right seat section in a scooping motion to support a bottom portion of the user's body. This forms the seat 400 under the bottom portion of the user's body for the user to sit on. The user can then actuate the electronic control module to control movement of the mobility assistive device 100.

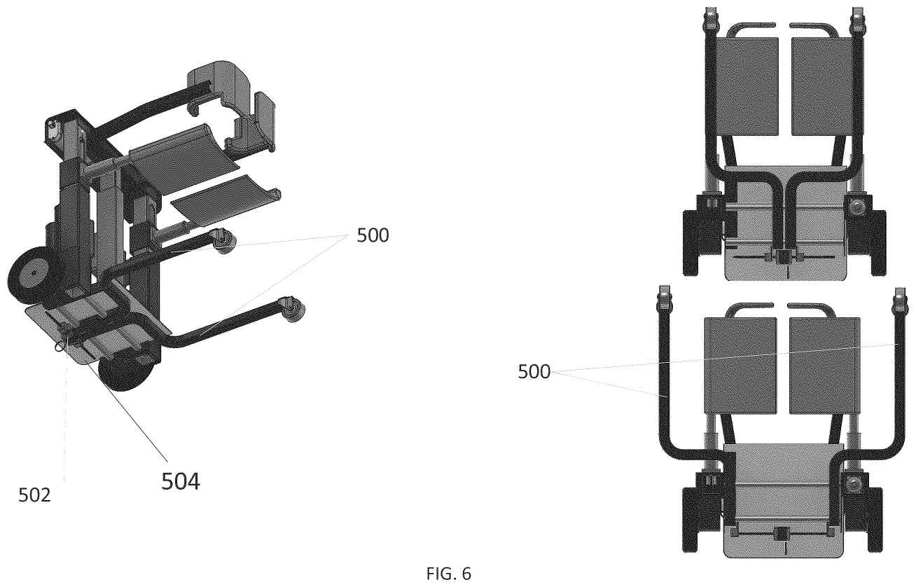

FIG. 6 shows example perspective views of the support legs 500 disposed in the bottom of the mobility assistive device 100 in closed (right, top) and open (right, bottom) positions. The device 100 comprises a support legs actuator 502 disposed on the support legs 500. In FIG. 6, the mobility assistive device 100 includes two support legs 500. The electrical control module can be configured to adjust the distance between the two support legs 500 via the support legs actuator 502. The distance between the two support legs 500 can be adjusted to be lesser than distance between legs of the object that the user is seated on (i.e., chair, bed, etc.) to enable the mobility assistive device 100 to be closer to the user in a seated position. The electronic control module can be used to independently move either of the two support legs 500, apart from each other. The support legs actuator 502 can further be configured to move the support legs 500 in the vertical axis of the main frame 110 to enable the footrest 504 disposed on the main frame 110 to contact the feet of the user.

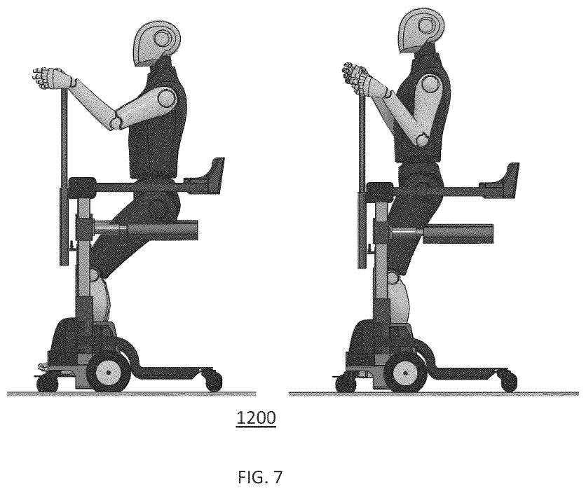

FIG. 7 shows an example use 1200 of the mobility assistive device 100 to be used in rehabilitation training to assist a user to stand-up. The user can actuate the electronic control module to control the movement of the left arm rest section 200a and right arm rest section 200b to move along the horizontal plane of the main frame 110 such that both the arm rest 200 sections can be positioned closer to the user's body to provide stability when trying to stand-up. The user can also actuate the electronic control module to control the movement of the handlebar 700 along the vertical axis of the main frame 110. The user can use the electronic control module to move the left seat section and the right seat section in a scooping motion to support a bottom portion of the user's body. This forms the seat 400 under the bottom portion of the user's body for the user to sit on. The user can then use electronic control module to lift the seat 400 to take a semi-standing position, while supported by the seat 400. The user can then grip on the handlebar 700 to lift their body from a semi-standing position to a standing position. The user can then lift their body from a semi-standing position while leaning on the handlebar 700 and rest their feet on the footrest 504 to practice standing up during rehabilitation training.

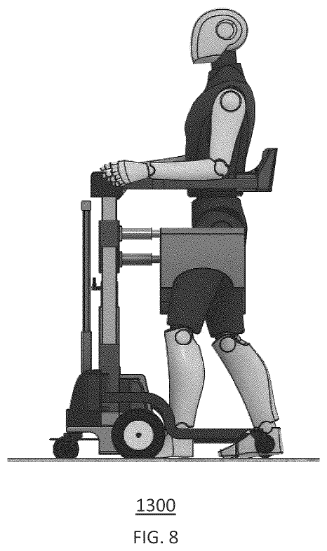

FIG. 8 shows an example use 1300 of the mobility assistive device 100 to be used in gait training to assist the user to walk while assisted. The user can actuate the electronic control module to control the movement of the left arm rest section 200a and right arm rest section 200b to move along the horizontal plane of the main frame 110 such that both the arm rest 200 sections can be positioned closer to the user's body to provide stability when trying to stand-up. The user can also actuate the electronic control module to control the movement of the handlebar 700 along the vertical axis of the main frame 110. The user can then grip on the handlebar 700 to lift their body from a seated position. The user can use the handlebar 700 and the arm rest 200 as stability support for the body of the user, the support legs 500 and the at least one wheel 600 for movement while gait training with the mobility assistive device 100.

While the advantages and preferred embodiments of the present invention have been described hereinbefore, those skilled in the art should be understood that the above are merely several illustrative embodiments of the present invention without limiting the scope thereof, wherein various modifications, alterations or substitutions may be made to the specific components of the embodiments without departing from the spirit and scope of the invention and its claims.

What is claimed is:

1-31. (canceled)

32. A mobility assistive device to provide mobility assistance to a user positioned in a seated position comprising:
a main frame;
an arm rest coupled to the main frame, the arm rest configured to move along a horizontal plane of the main frame and along a vertical axis of the main frame;
a back rest coupled to the arm rest, the back rest configured to support a portion of the body of the user;
a seat movably coupled to the main frame and configured to move about the main frame in a two-dimensional scooping motion, the seat comprising:
a left seat section;
a right seat section; and
a seat movement mechanism comprising at least one actuator, the seat movement mechanism configured to:
move the left seat section and the right seat section along the vertical axis of the main frame using the at least one actuator; and
simultaneously rotate the left seat section and the right seat section about a horizontal axis of the main frame, performing a two-dimensional scooping motion to form the seat conforming to a shape of the user; and
at least one lifting mechanism coupled to the seat and the main frame, the at least one lifting mechanism being configured to move the seat, the arm rest, and the back rest along the vertical axis of the main frame.

33. The mobility assistive device of claim 32, wherein the arm rest comprises:
a left arm rest section;
a right arm rest section;
a left connection segment, wherein a distal end of the left connection segment is movably connected to the left arm rest section;
a right connection segment, wherein a distal end of the right connection segment is movably connected to the right arm rest section;
a rotating block disposed on the main frame and connected to a proximal end of the left connection segment and a proximal end of the right connection segment, the rotating block configured to rotate about the vertical axis of the main frame; and
at least one arm rest actuator configured to move the left arm rest section and the right arm rest section along the horizontal plane of the main frame.

34. The mobility assistive device of claim 33, the left arm rest section and the right arm rest section are configured to move along the horizontal plane of the main frame by actuation of the rotating block by the at least one arm rest actuator, the left arm connection segment, and the right arm connection segment.

35. The mobility assistive device of claim 33, wherein the back rest comprises a left section and a right section, wherein the left section of the backrest is coupled to the left arm rest section, and the right section of the backrest is coupled to the right arm rest section.

36. The mobility assistive device of claim 32, wherein the seat movement mechanism further comprises:
a first carriage movably mounted on a first column and in contact with the left seat section and a second carriage movably mounted on a second column and in contact the right seat section, each carriage containing at least one carriage actuator; and
an eccentric block contained within each carriage and in contact with the respective seat section, the eccentric block configured to rotate the respective seat section when the respective carriage with is moving along the vertical axis and the eccentric block is contacted by a slot plate contained within the respective vertical column;
each vertical column configured to allow the respective carriage, the eccentric block, the seat section to move along the vertical axis of the main frame such that the seat sections close in the two-dimensional scooping motion.

37. The mobility assistive device of claim 32, wherein the seat movement mechanism further comprises:
for each of the left seat section and the right seat section, a gear disposed on a seat shaft and a gear track configured to receive the gear, the gear configured to rotationally move along the gear track to rotate the left seat section and the right seat section, respectively, in a two-dimensional scooping motion, when the carriage with the seat section is moving along the vertical axis of the main frame.

38. The mobility assistive device of claim 32, further comprising:
at least one support leg attached to the main frame; and
at least one selectively rolling wheel disposed on the at least one support leg and configured to allow the user to move the mobility assistive device.

39. The mobility assistive device of claim 38, further comprising an electric control module disposed on the arm rest, the handlebar, or main frame, the electric control module configured to allow the user to control movement of the at least one selectively rolling wheel.

40. The mobility assistive device of claim 39, wherein the electric control module is further configured to allow the user to control movement of the handlebar, the arm rest, the at least one support leg and the seat.

41. The mobility assistive device of claim 39, wherein the electrical control module is configured to be controlled by voice control.

42. The mobility assistive device of claim 39, wherein the electrical control module comprises at least one tactile feature configured to be operable by the user to allow the user to control the mobility assistive device.

43. The mobility assistive device of claim 39, wherein the electrical control module comprises programmable routes for the movement of the mobility assistive device.

44. The mobility assistive device of claim 43, wherein the movement of the mobility assistive device via the programmable routes is configured to be activated by voice control.

45. The mobility assistive device of claim 39, wherein the main frame comprises at least one sensor configured to:
prevent the mobility assistive device from colliding with other objects during movement of the mobility assistive device; and position the mobility assistive device alongside the body of the user.

46. The mobility assistive device of claim 32, wherein the backrest is configured to support:
a lower back region of the user's body; or
a region of the user's body directly under the user's arms.

47. The mobility assistive device of claim 33, wherein the at least one arm rest actuator further includes:
a first arm rest actuator disposed on the left arm rest section, the first arm rest actuator configured to move the left arm rest section about the vertical axis of the main frame; and
a second arm rest actuator disposed on the right arm rest section, the second arm rest actuator configured to move the right arm rest section about the vertical axis of the main frame, wherein the left arm rest section and the right arm rest section can move independently of each other.

48. The mobility assistive device of claim 32, wherein the seat movement mechanism further includes:
a first carriage in contact with the left seat section and a second carriage in contact with the right seat section, the first carriage and the second carriage each configured to contain a bearing;
a first linear actuator functionally coupled to the first carriage and a second linear actuator functionally coupled to the second carriage, each linear actuator configured for movement of the respective seat section along the vertical axis of the main frame; and
a first rotary actuator functionally coupled to the first carriage and a second rotary actuator functionally coupled to the second carriage, each rotary actuator configured for movement of the respective seat section in a two-dimensional scooping motion, when the carriage is moving along the vertical axis of the main frame.

49. The mobility assistive device of claim 32, further comprising a handlebar movably coupled to the main frame and a handlebar lifting mechanism operably coupled to the handlebar, the handlebar configured to:
move along the vertical axis of the main frame via the at least one lifting mechanism; and
assist the user to lift the body of the user from the seated position.

50. The mobility assistive device of claim 49, wherein the handlebar lifting mechanism is configured to control movement of the handlebar, and wherein the handlebar lifting mechanism is separate from the at least one lifting mechanism.

51. A method of providing mobility assistance to a user positioned in a seated position, the method comprising:
providing a mobility assistive device to the user in the seated position, the mobility assistive device comprising:
a main frame;
an arm rest coupled to the main frame, the arm rest configured to move along a horizontal plane of the main frame; a back rest coupled to the arm rest, the back rest configured to move along a vertical axis of the main frame to support a portion of a body of the user;
a seat movably coupled to the main frame and configured to move about the main frame in a scooping motion, the seat comprising:
a left seat section;
a right seat section; and
a seat movement mechanism comprising at least one actuator, the seat movement mechanism configured to:
move the left seat section and the right seat section along the vertical axis of the main frame; and
simultaneously rotate the left seat section and the right seat section about a horizontal axis of the main frame in a two-dimensional scooping motion to conform to a shape of the user to form the seat;
a handlebar movably coupled to the main frame, the handlebar configured to:
move along the vertical axis of the main frame; and
assist the user to lift the body of the user from the seated position;
at least one lifting mechanism coupled to the seat and the main frame, the at least one lifting mechanism being configured to move the seat, the arm rest, and the handlebar along the vertical axis of the main frame;
actuating an electronic control module disposed on the arm rest or the main frame to move the arm rest and the handlebar;
moving the handlebar in the vertical plane of the main frame to position the handlebar for gripping by hands of the user;
moving the arm rest in the horizontal plane of the main frame to position the arm rest near the body of the user;
moving the arm rest about the vertical axis of the main frame to position the back rest to support a portion of the body of the user; and
lifting the body of the user from the seated position with the arm rest, the back rest, and the handlebar, by actuating the electronic control module to move the seat in the two-dimensional scooping motion to support a lower portion of the body of the user; and
actuating the electronic control module to control movement of the mobility assistive device via at least one selectively rolling wheel.
